(19) United States
(12) Patent Application Publication
(10) Pub. No.: US 2013/0271291 A1
(43) Pub. Date: Oct. 17, 2013

(54) METHOD OF ALERTING AN OPERATOR OF A VEHICLE OF A HAZARDOUS CONDITION

(71) Applicant: Nathaniel J. Tebbe, Ellsworth, IA (US)

(72) Inventor: Nathaniel J. Tebbe, Ellsworth, IA (US)

(21) Appl. No.: 13/447,383

(22) Filed: Apr. 16, 2012

(51) Int. Cl. G08G 1/0965; G08G 1/00

(52) U.S. Cl. 340/902; 340/901

(57) ABSTRACT

A method of alerting an operator of a vehicle of a hazardous condition. The steps include sending a warning signal with a transceiver from a first vehicle that is received by a transceiver in a second vehicle. The transceiver then sends a signal to the computing device of the second vehicle that actuates an indicating assembly in order to alert a driver that a hazardous condition is in their area.

### BACKGROUND OF THE INVENTION

This invention relates to an alert system for a vehicle.

More specifically this invention relates to a method of alerting an operator of a vehicle of a hazardous condition.

Currently vehicles such as cars, trucks, school buses, boats, motorcycles, emergency vehicles, trains, slow moving vehicles and the like traverse over the road, on a waterway or the like and an operator of a vehicle must continually be on the outlook for hazardous conditions while operating the vehicle. Specifically, if another vehicle is stopped and has turned on their hazard lights, if there is an accident, inclement weather or another vehicle on the roadway such as a motorcycle that is difficult to see, an individual must spot the hazard before they are able to slow their vehicle and adjust as a result of the hazard. Problems exist in that individuals do not always focus on operating the vehicle. Individuals change radio stations, talk on cell phones, daydream, get side tracked by children in the car, or the like when traveling and thus oftentimes when a hazardous condition is presented an operator will not see the hazardous condition until it is too late for them to react causing an accident, the operator to swerve, or other undesirable results.

Over the years methods and systems have been developed in order to attempt to address these types of issues. In particular school buses have utilized stop signs with flashing lights on them to try to provide warnings to other drivers that they are stopped. Similarly, emergency vehicles utilize flashing lights and sirens in order to make other drivers aware of an emergency situation. Hazards can be deployed on a vehicle that is stopped to provide blinking and warning lights to oncoming traffic. Boats similarly use horns and fog lights to make other boats and vehicles aware of their presence during inclement weather or in the dark. Further GPS devices such as Tom Toms use GPS signals in order to indicate when traffic is particularly heavy and/or receive signals that a traffic accident has occurred.

While these advancements have helped provide warnings to operators of vehicles deficiencies still remain. In particular, when an emergency vehicle is coming from behind an individual or from a side street, often even the flashing lights cannot be seen. Further, oftentimes when a horn is sounded by an emergency vehicle while a vehicle operator will look around to try to locate the flashing lights, at blind intersections that use stop lights locating such emergency vehicles often is still very difficult. Further, when school buses or vehicles that have hazards are located at the top of a hill or around a curve often such hazardous conditions cannot be detected until an operator of a vehicle is on top of or over the top of the hill or around a curve in order to witness such hazardous conditions. In the cases of motorcycles that are often difficult for other drivers to recognize they are not detected until it is too late for a vehicle operator to adjust their driving.

In embodiments where the vehicle is a boat deficiencies include buoys for boaters that indicate a no wake zone are difficult to see. Similarly for boaters there is no way of indicating to a second boat that a primary boat has divers that are down. Water skiers can often be difficult to see. Thus, a need in the art exists for an improved system of identifying hazards caused by vehicle.

In other situations warning systems that currently are inadequate to get individuals' attention. For example, school zones are marked with flashing lights or signs. Similarly, emergency 911 postings including “Amber Alerts” are marked with overhead signs that are typically difficult to read while driving. A need for in the vehicle warnings or systems is therefore desired.

Thus, a principal object of the present invention is to provide a method of alerting an operator of a vehicle of a hazardous condition that gives ample notice time of a hazardous condition.

Yet another object of the present invention is to provide a method of alerting an operator of a vehicle of a hazardous condition that is inexpensive and easy to operate.

These and other objects, features and advantages will become apparent from the specification and claims.

### BRIEF SUMMARY OF THE INVENTION

A method of alerting an operator of a vehicle of a hazardous condition. This is accomplished by first sending a warning signal with a transceiver from a first vehicle that is received within a computing device of a second vehicle. The computing device of the second vehicle then alerts the operator of the second vehicle of the hazardous condition with an indicating assembly associated with the vehicle upon receiving the warning signal.

### BRIEF DESCRIPTION OF THE DRAWINGS

FIG. 1 is a schematic diagram of a hazardous alert system; and

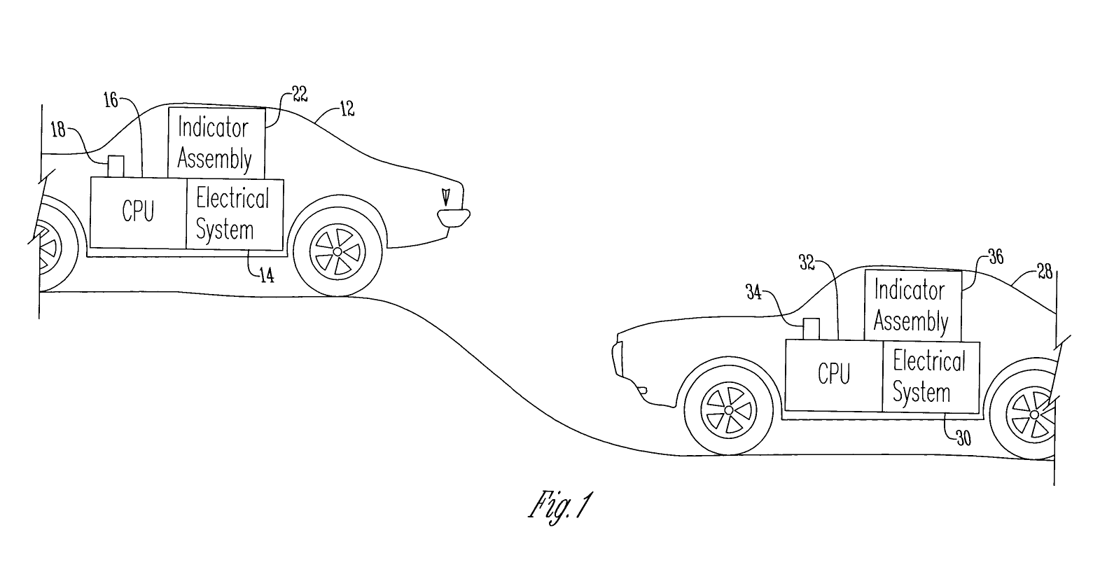

FIG. 2 is a schematic diagram of a hazardous alert system.

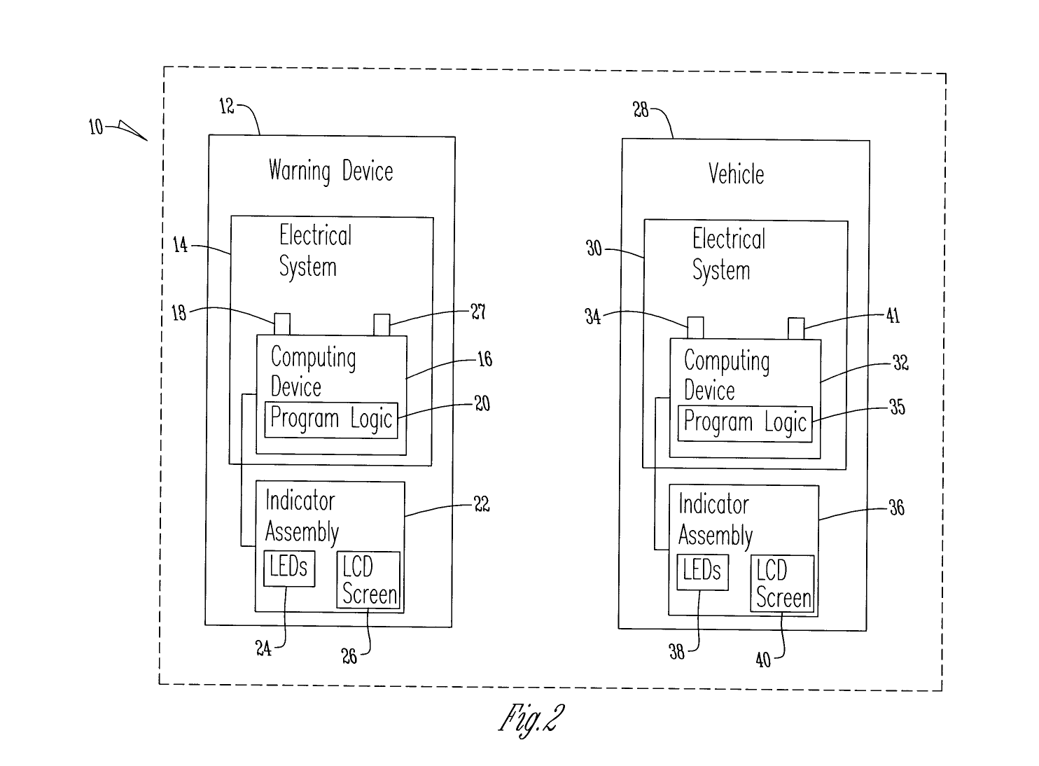

### DETAILED DESCRIPTION OF THE PREFERRED EMBODIMENT

The figures show a hazardous alert system 10 that includes a warning device 12 that in one embodiment is a first vehicle 12 that can be a car, boat, airplane, truck, motorcycle, semi-truck, sports utility vehicle, school bus, emergency vehicle, trains, slow moving vehicles or the like. The first vehicle 12 has an electrical system 14 that controls the operation of the vehicle including electrical control of steering functions, driving functions and the like and optionally of electrical systems such as door locks, air conditioning, and the like as is known in the art. Associated with the electrical system and preferably integrated within the electrical system 14 is a computing device 16.

The computing device 16 includes a transceiver 18 that is able to send and receive short range electrical signals via radio frequency, preferably TX or RX radio frequency. In this manner the transceiver is able to relay and receive signals as desired from the computing device 16. The computing device 16 has programming logic 20 that encrypts and deciphers transmissions received and sent to the transceiver 18. An indicating assembly 22 is electrically connected to the computing device 16 and contains indicator lights 24 such as light emitting diodes (LEDs) and/or an LCD screen 26 or display that is able to flash, blink, provide an audio cue or bring awareness to an operator of a vehicle of a hazardous condition. In one embodiment the computing device can include a sensor 27 can determine when the sensor 27 is submerged in water and have the computing device send out communication regarding the fact the vehicle is submerged and the location of the vehicle.

A vehicle 28, that in an embodiment where the warning device 12 is a first vehicle 12 is a second vehicle 28, similarly has an electrical system 30, computing device 32, a transceiver 34, program logic 35 an indicating assembly 36 having indicator lights 38 or an LCD screen 40 and a sensor 41 identical to the first vehicle. Specifically, the transceiver 34 of the second vehicle 28 is in over the air communication with the transceiver 18 of the first vehicle 12 such that electric signals can be generated by the transceiver to send to and from the first and second vehicles 12 and 28 to provide a communication path between the first and second vehicles 12 and 28. Alternatively, the transceiver 34 is in communication with a warning device 12 such as a school broadcasting systems, road broadcasting systems provided by the department of transportation, emergency 911 broadcasting systems, “Amber Alert” broadcasting systems or the like to provide audio broadcasts and information from these systems. Information can include, but is not limited to, emergency 911 information, weather conditions, road closing updates, school zone warnings, and the like.

In operation, when a hazardous condition is presented the transceiver 18 of the warning device 12 sends out a warning signal that is received by the transceiver 34 of the second vehicle 28. The computing device 32 of the second vehicle 28 then actuates the indicator assembly 36 in order to cause the indicating assembly to flash, show the location of the hazardous condition on an LCD screen 40 or the like in order to warn the driver or operator of the second vehicle 28 of the hazardous condition.

In a first embodiment the warning signal is sent from the first vehicle 12 when the hazard lights of the first vehicle are actuated. In another embodiment the warning signal is sent from the first vehicle when the first vehicle is in operation. In this manner vehicles such as motorcycles or boats that are often difficult to see or locate provide a warning signal such that their presence may be known by the operator of the second vehicle 28.

In yet another embodiment the warning signal is sent from an emergency vehicle or alternatively from a school bus when the school bus makes a stop. Again, in this manner the operator of the second vehicle 28 can be alerted of the stopped school bus or emergency vehicle. In another embodiment when airbags of a first vehicle 12 deploy the warning signal is sent to the second vehicle 28 to warn that an accident has occurred and airbags have been deployed at a certain location. Similarly, when an individual uses a boat, other boats can be detected thus making this system 10 effective to be used in inclement weather such as fog or at night.

Thus provided is a hazardous alert system that allows for a method of alerting an operator of a vehicle of a hazardous condition. The system sends warning signals and information to vehicles when a hazardous condition occurs such as a vehicle utilizing the vehicles' hazardous lights, an emergency vehicle, a stopped vehicle, a motorcycle, deployment of airbags, or any other hazardous condition that typically can be difficult for an operator of a vehicle to detect is occurring. In this manner, should an operator of a vehicle be distracted because of daydreaming, talking on a cell phone, taking care of children, or the like the indicating assemblies 22 or 36 alert an operator that they need to be aware that a hazardous condition is occurring within their driving range. This will bring the operator's attention clearly on the road and allow an operator to begin slowing down in anticipation that a hazardous condition is presented. Thus, at the very least all of the stated objectives have been met.

It will be appreciated by those skilled in the art that other various modifications could be made to the device without departing from the spirit and scope of this invention. All such modifications and changes fall within the scope of the claims and are intended to be covered thereby.

What is claimed is:

1. A method of alerting an operator of a vehicle of a hazardous condition steps comprising:
sending a warning signal with a transceiver from a warning device;
receiving the warning signal with a computing device of a vehicle; and
alerting the operator of the vehicle of a hazardous condition with an indicating assembly upon receiving the warning signal.

2. The method of claim 1 wherein the vehicle is chosen from a group consisting of car, truck, motorcycle, boat, semi-truck, sport utility vehicle, school bus, train and emergency vehicle.

3. The method of claim 1 wherein the vehicle has a computing device electrically connected to the transceiver.

4. The method of claim 3 wherein the computing device is integrated into a computer system of the vehicle.

5. The method of claim 1 wherein the warning signal is sent from the warning device when hazard lights of a second vehicle are activated.

6. The method of claim 1 wherein the warning device is a second vehicle and a warning signal is sent from the second vehicle when the second vehicle is in operation.

7. The method of claim 1 wherein the warning device is associated with an emergency vehicle.

8. The method of claim 1 wherein the warning device is associated with a school bus and the warning signal is sent when the school bus makes a stop.

9. The method of claim 1 wherein the warning device is associated with a second vehicle and a warning signal is sent when an airbag of the second vehicle is deployed.

10. The method of claim 1 wherein the warning device is associated with a boat and a warning signal indicates individuals are in the water.

11. The method of claim 1 wherein the warning device is a buoy having a transceiver that sends the warning signal.

12. The method of claim 1 wherein the warning device is an emergency 911 system.
